(19) United States
(12) Patent Application Publication
(10) Pub. No.: US 2006/0031535 A1
(43) Pub. Date: Feb. 9, 2006

(54) Media gateway for provision of the pst/isdn services in next-generation networks

(75) Inventors: Kathrin Hackl, Neubeuern (DE); Walter Held, Geretsried (DE); Hanspeter Ruckstuhl, Wolfratshausen (DE)

Correspondence Address: Siemens Corporation;Intellectual Property Department, 170 Wood Avenue South, Iselin, NJ, 08830, US

(73) Assignee: Siemens Aktiengesellschaft, Munchen (DE)

(21) Appl. No.: 10/523,199

(22) PCT Filed: Jul. 10, 2003
(86) PCT No.: PCT/EP03/07520

§ 371 Date: Jan. 27, 2005

(30) Foreign Application Priority Data
Jul. 29, 2002 (EP) 02017090.8

(51) Int. Cl. G06F 15/16

(52) U.S. Cl. 709/228

(57) ABSTRACT

Packet-based networks of the next generation work on the principle of separation of connection and data channel control. In the above networks, as opposed to current TDM networks, discrete network elements are used for connection control and data channel control, whereby the network element for data channel control is defined as Media Gateway and the network element for connection control is defined as Media Gateway Controller. Problems arise as a result of the physical and positional separation of the connection and data channel control, in particular the problem of performance loss as a result of greatly increased incoming signaling messages and greater distance-related signal delay times. According to the invention, said problems are solved whereby a part of the connection control is integrated in the Media Gateway, whilst the remaining part of the connection control, in particular that concerning the central control and monitoring tasks remains, as before, in the media gateway controller.

### CROSS REFERENCE TO RELATED APPLICATIONS

This application is the U.S. National Stage of International Application No. PCT/EP03/007520, filed Jul. 10, 2003 and claims the benefit thereof. The International Application claims the benefits of European application No. 02017090.8 EP filed Jul. 29, 2002, both of the applications are incorporated by reference herein in their entirety.

### FIELD OF INVENTION

This invention relates to a media gateway for provision of the PSTN/ISDN services in next-generation networks.

### BACKGROUND OF INVENTION

In present-day speech networks (PSTN/ISDN) based on the circuit-switching principle, the local and transit exchanges are responsible for both connection control and data channel control (e.g. two-party connection, three-party connection, tone provision).

Next-generation networks (abbreviated to NGN) are packet-based (e.g. ATM or IP as the transport layer) and are designed to transport both speech and data. They work on the principle of separation of connection and data channel control. In such networks, as opposed to current TDM networks, discrete network elements are used for connection control (call and signaling control) and data channel control (bearer or media control). Connection control is handled by media gateway controllers (MGC), which use a media gateway control protocol (MGCP), of which MGCP or H.248 are currently available, for communicating with the media gateways (MG), which control the data channels. The signaling is terminated in the media gateway controller.

The media gateway controllers in the NGN communicate with one another via a signaling protocol (e.g. BICC protocol) in a similar manner to PSTN/ISDN exchanges (e.g. No. 7 signaling).

The network elements (MGC and MG) are physically and normally also spatially separated. Spatially separated can mean that a MG and its controlling MGC are many hundreds of kilometers apart or even communicate with one another via satellite. As a rule a media gateway controller handles the connection control for a plurality of media gateways. According to the present-day understanding of NGN architecture (master-slave concept), a media gateway without a media gateway controller is not in a position to switch connections independently or to take other decisions about connection control.

FIG. 1 shows the principle of the present-day PSTN/ISDN networks.

FIG. 2 shows an example of the speech communication principle in next generation networks according to the present-day understanding of NGN.

The physical and positional separation of the connection control and data channel control, together with the handling carried out by the media gateway controller and the media gateway, give rise to the problems described in the following points:
Performance loss as a result of greatly increased incoming signaling messages and greater distance-related signal delay times
Limited availability of subscriber or connection circuits in the event of a fault in the packet-switching network or in the controlling media gateway controller
Problems with applying an accurate time charge for connections

Performance Loss as a Result of Greatly Increased Incoming Signaling Messages and Greater Distance-Related Signal Delay Times

Compared to conventional telephone architecture, when connection control and data channel control for subscriber connections are separate, a considerably larger number of time-critical signaling messages have to be exchanged between the media gateway controller and the media gateway for the purpose of synchronous data channel control. For example the signaling messages received by the terminating equipment in the case of an ISDN subscriber must initially be sent to the controller via a protected protocol. The media gateway controller then evaluates the signaling messages and uses the control protocol to order the media gateway to switch on the ringing tone, for instance. On receiving the address signal this is initially returned to the controller until the latter orders the tone to be turned off. A still greater flood of messages is generated in the case of an analog subscriber when the individual dialed digits are received and forwarded.

The large number of messages exchanged between the MG and the MGC for establishing a call, combined with the transmission of these messages via an external interface over potentially long distances, can lead to very noticeable delays when establishing a connection. The delays on the one hand have the effect of restricting function when time-critical tasks such as switching on the code receiver are being carried out, and on the other hand can lead to a situation where the existing time requirements of the external subscriber signaling interface can no longer be maintained in a NGN.

Limited Network Availability—Impossible to Establish a Connection in the Event of a Fault in the Network or if the Media Gateway Controller Fails

Being totally devoid of any local connection control, and therefore totally dependent on the media gateway controller, a media gateway is unable to operate the subscriber data channels connected to it if the media gateway controller drops out or if there is an interruption to the signaling between the MG and the MGC due to network disruption. The failure of a media gateway controller therefore always means the failure of all the media gateways it controls together with all connected subscriber and connection circuits. In such cases no emergency calls can be made either. Since a media gateway controller usually controls several media gateways, very many connections can be affected by a fault of this kind.

Applying an Accurate Time Charge

The separation of connection control and data channel control can lead to problems with accurately recording the charging, since the data channel is operated in the media gateway but time stamp recording takes place in the media gateway controller.

The technical problems indicated were hitherto unknown and result from using the standardized function split for the purpose of providing the conventional telephony services in next generation networks (copying the PSTN/ISDN).

To a limited extent, comparable problems in the use of a purely master-slave principle occur for TDM networks when defining conventional access networks. In this case the access network is connected to a TDM switch via the V5 interface, the TDM switch operating as the master and the access network as the slave.

The problem with connecting an access network to a TDM switch differs in the following respects from the problems involved in using the NGN architecture,
(a) there is normally limited spatial separation,
(b) the control and signaling messages are exchanged with the aid of a protected, available message channel having a fixed, defined bandwidth,
(c) compared to a media gateway an access gateway has only limited data channel control, since the data channel is used by the TDM switch. In the same way, the data channel is fed via the TDM switch and it is only there that tones are generated or charging takes place.
   The problem of handling time-critical tasks has been solved by introducing conditional instructions. The problem of limited availability has not been solved.

### SUMMARY OF INVENTION

One aspect of the present invention provides a media gateway of a packet-based communication network, comprising:
a data channel controller which controls a data channel of a first communication connection;
a terminator that terminates a signaling message of a second communication connection; and
a connection controller that performs a first part of a connection control function for a third communication connection and authorizes a central network controller to carry out a second part of the connection control function.

Another aspect of the present invention a controller in a packet-based communication network for connection control which carries out connection control functions centrally in the network for a communication connections, comprising:
a media gateway operatively attached to the controller,
wherein the controller receives a task for performing the connection control from the media gateway, the controller either carries out the tasks itself or controls further execution of the tasks instead of the media gateways.

Another aspect of the present invention a method for handling a communication connection in a packet-based network, comprising:
receiving an incoming signaling message from a circuit selected from the group consisting of subscriber circuit, connection circuit, and combinations thereof;
evaluating the incoming signaling;
performing a first part of a connection control by a media gateway; and
authorizing by the media gateway a central network controller to perform a second part of a connection control.

### BRIEF DESCRIPTION OF THE DRAWINGS

In the drawings:

FIG. 1 shows the principle of the present-day PSTN/ISDN networks.

FIG. 2 shows an example of the speech communication principle in next generation networks according to the present-day understanding of NGN.

FIG. 3 shows a new function split for NGNs.

FIG. 4 shows fundamental communication relationships.

FIG. 5 shows a comparison between architectures using the conventional NGN approach and the approach embodied by the hiA 7600.

FIG. 6 shows the network image for a basic call in which both ports are assigned to the control proxy.

FIG. 7 shows the flow of signaling messages associated with the basic call mentioned in FIG. 6.

FIG. 8 shows the network image for a basic call in which only incoming access is controlled by the control proxy.

FIG. 9 shows the signaling flow associated with FIG. 8.

FIG. 10 shows the intelligent access gateway approach corresponds to the function split pursued by SIP, making it possible to integrate access gateways into the world of SIP. The access control protocol is replaced by the standardized SIP protocol.

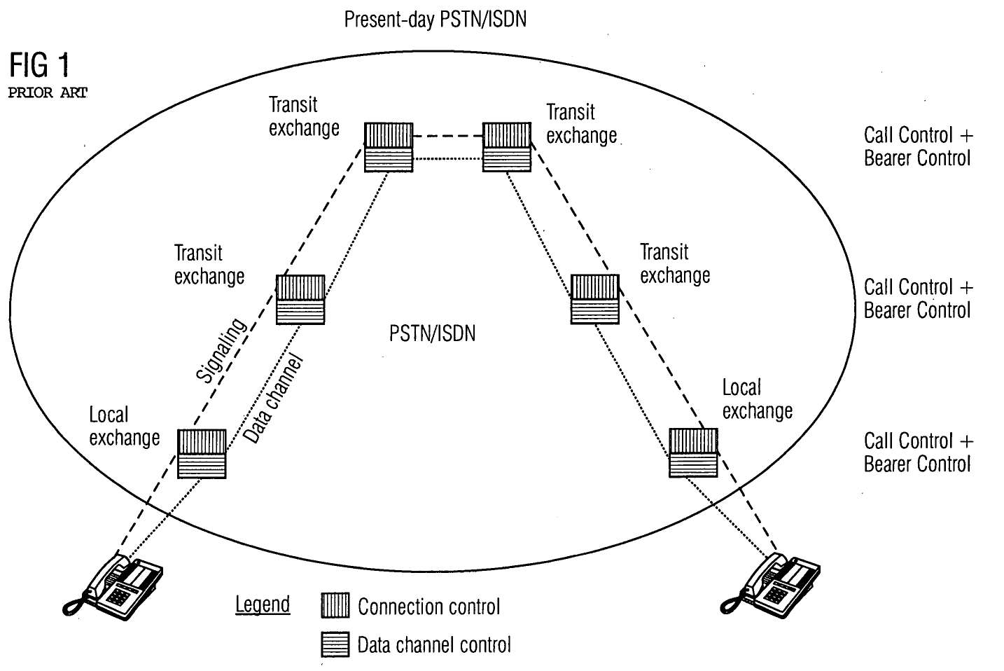

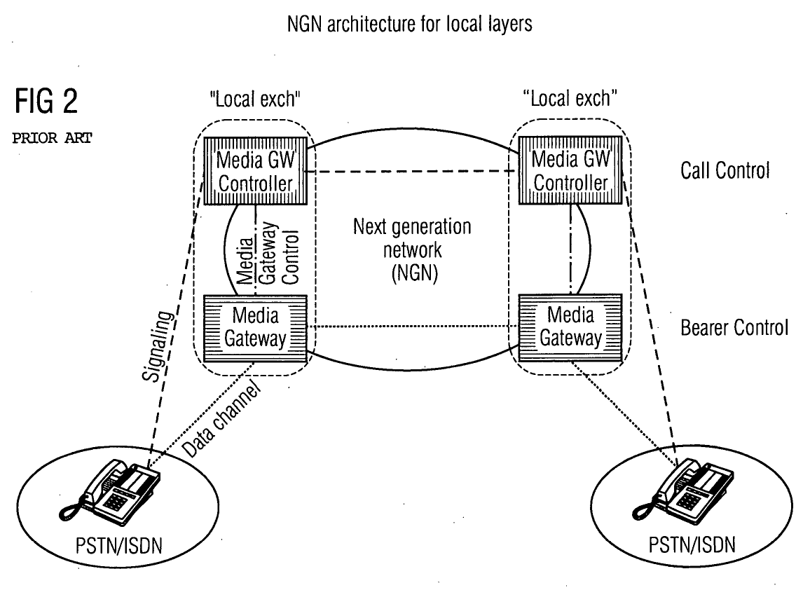

### DETAILED DESCRIPTION OF THE INVENTION

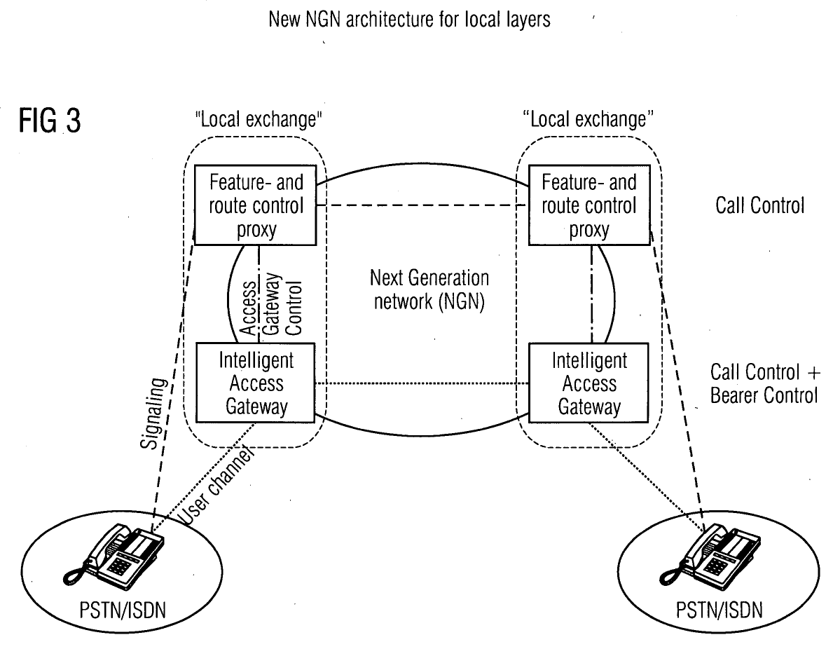

The invention proposes a new function split for NGNs, as shown in FIG. 3. Instead of the strict master-slave split used in the NGN concept, a proxy-client approach is selected in which a part of the connection control is integrated in the media gateway, whilst the remaining part of the connection control, in particular that concerning the central control and monitoring tasks, remains in the media gateway controller as before. The media gateway controller to which the invention relates will from here on be referred to as a central network controller and the media gateway to which the invention relates will from here on be referred to as an intelligent access gateway.

In contrast to a “master-slave” relationship, in which total control over a connection rests with the media gateway controller (=master), and in which an access gateway (=slave) only reports events to the media gateway controller and carries out the orders from this controller regarding connection control, a client-proxy approach is selected in the present invention. According to this approach the intelligent access gateway (=client) is the termination for the above-mentioned events (signaling) and carries out a part of the connection control functions itself, in particular those connection control functions which do not necessarily need to be provided by a central network controller (=proxy), but instead can be provided directly by a client or can be negotiated between the clients taking part in a connection.

It authorizes one of the central network controllers to carry out the remaining part, and the controller itself either carries out the task or controls any further execution of the task instead of the gateway.

In the case of the connection control functions which the intelligent access gateway (client) carries out itself, the functions for the client of the calling subscriber (A) or for the client of the called subscriber (B) include:
Generating the dial tone (A)*
Accepting the address signal (A)*
Indicating the call number of the calling subscriber via FSK in the case of analog subscribers (B)*
Call repetition on “subscriber busy” (A and B)
Negotiating between the partners to determine which side bears the call charge (A and B)
Recording charge data (A and/or B)*
Transferring charge information on the charging side to the subscriber terminating equipment (A or B)
Exchanging the necessary terminating point data (IP address, port number, codec information, etc.) for making through-connections (A and B)*
Managing add-on third-party conference calls (A or B)
Autonomous call routing to selected, permanently administered destinations (e.g. emergency call numbers) in the event of a failure of the proxy (A or B)

A great advantage of the invention arises first and foremost from the adoption of those time-critical connection control functions which are receptive to local processing (those functions which are time-critical are marked with an asterisk (*) in the above list).

Due to the above-mentioned adoption of connection control functions by the access gateways, the task of the central network controller (media gateway controller, proxy) is reduced in the area of connection control to functions which need a central database, such as call routing or the preparation of charging information, and to the coordination of certain features which can be distributed to a plurality of clients (e.g. centrex). The central network controller will therefore from here on also be referred to as the feature and route control proxy (see FIG. 3).

In addition to the connection control functions mentioned, the intelligent access gateway takes on the termination of signaling (subscriber circuit signaling and connection circuit signaling) and continues to handle data channel control. In the case of the function split mentioned, the subscriber data is advantageously stored and managed in the intelligent access gateway.

The invention solves all three of the problem areas listed above in equal measure.

The Performance Loss Problem

All data channel settings are signaled by the local connection control components directly in the intelligent access gateway via an internal interface between connection control and data channel control. The evaluation of signaling messages can take place without delay and provision of the necessary resources can be requested immediately. This means there are no time-critical delays. Feature control messages are fewer in number and not time-critical by comparison. The same applies to call routing.

The Problem of Limited Network Availability

Due to local connection control and knowledge of the subscriber connections present in the intelligent access gateway, the gateway is able to carry out at least one limited connection control for all current subscriber connections, without needing to communicate with the feature and route proxy, if an alternative route proxy is available in the network, said proxy needing to have no knowledge whatsoever about existing subscribers.

Due to the local introduction of a fixed route for operating in emergency mode, calls can be made to connected emergency call exchanges even in the absence of a route proxy.

The Problem of Applying an Accurately Timed Charge

The necessary charging data is recorded immediately and with accurate timing in the intelligent access gateway since both the time stamping and switching of the data channel are carried out in the intelligent access gateway itself, so that delays over an external transport network cannot occur.

The data collected in relation to connection charges is then sent for further processing either directly or via the feature and route proxy to a higher-level charges processing system.

Comparing the Invention with the Conventional Function Approach

The NGN structure to which the invention relates arises from adopting elements of the conventional function approach into the combined data channel and connection control. The elements of conventional function control enable precise control of all the time-critical procedures in the connection and data channel control, whilst retaining the approach of a central call server for controlling access gateways. The option to use a large central call server, which in terms of spatial separation may even be a great distance from the access gateways distributed throughout the network, is greatly favored by the use of this architecture, since it means that propagation delays in the transport network cease to be a dimensioning criterion.

Exemplary Embodiment(s) of the Invention

The mark of an intelligent access gateway (IAGW) is the existence of a comprehensive call control function on the access gateway. Once the partners are known there are two basic options for communication between two IAGWs for the purpose of connection control:

All messages between one IAGW (client A) and the other IAGW (client B) are actually passed via the proxy, which forwards them to their destination without interpreting their contents.

When the proxy has informed client A of the destination address of client B, both clients communicate directly with one another. However, the proxy is occasionally included in the communication relationship if special central features are subsequently needed for the connection.

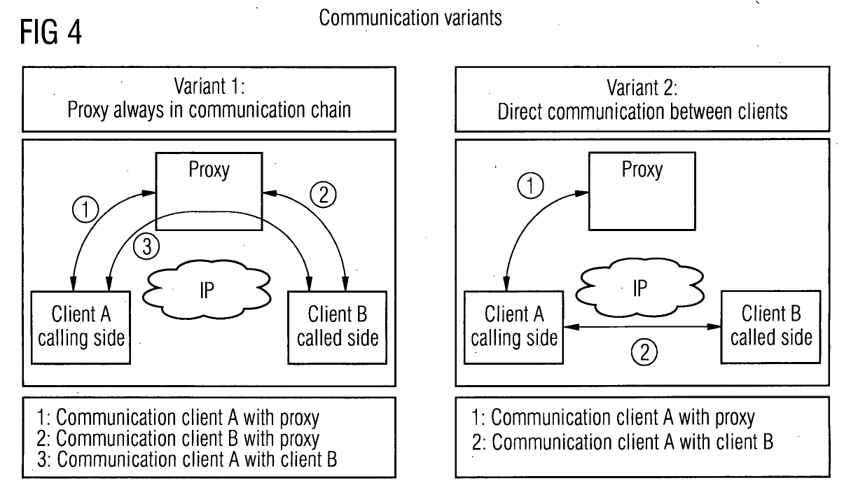

These fundamental communication relationships are shown in FIG. 4.

The intelligent access gateway approach was embodied for the first time in the SURPASS product line, with the development of the hiA 7600. In this the connection agent (CoX) function, which controls the sequences for establishing and clearing connections on the media gateway, moves from the media gateway controller to the media gateway itself.

The hiA 7600 intelligent access gateway is controlled by the hiQ 9200 feature and route control proxy. The messages between the MGC and the MG are exchanged via a proprietary access gateway control protocol, since the standardized protocols MGCP and H.248 have not been standardized for the desired function split and are used for data channel control only. However, in future versions it will also be possible to use the SIP protocol as a client-proxy protocol.

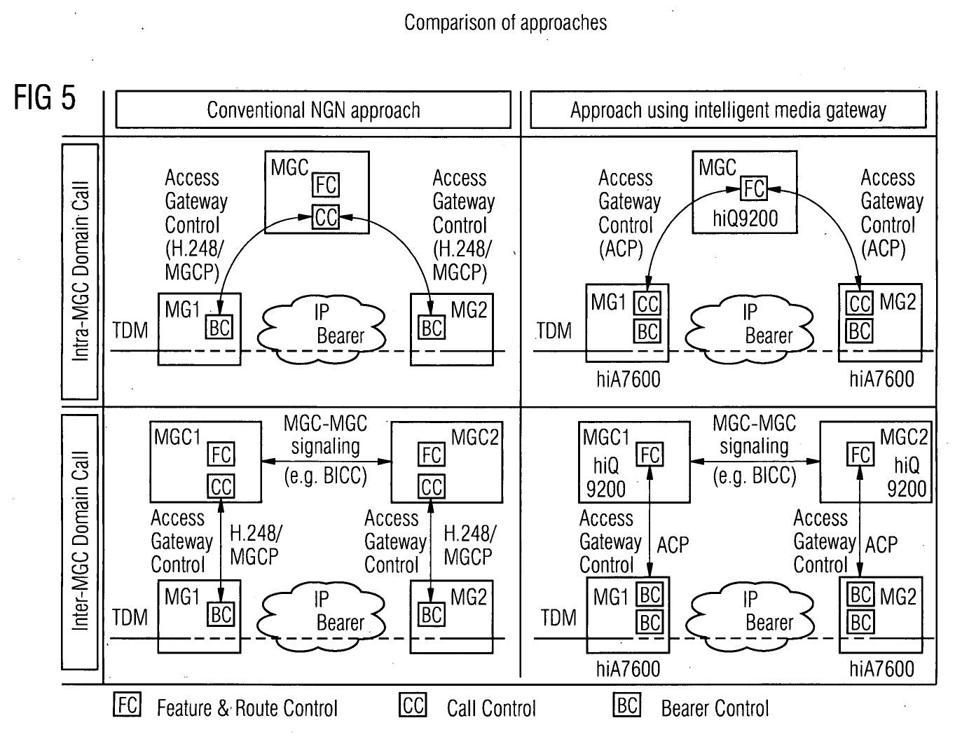

FIG. 5 shows a comparison between architectures using the conventional NGN approach and the approach embodied by the hiA 7600.

FIG. 5 clearly shows how in the new NGN approach the call control function is moved to the media gateway and the external H.248/MGCP interface becomes an internal system interface with all the associated advantages that were described in the above chapters. At the heart of the hiA 7600 is a call control processor which controls and executes the IP-TDM mediation. At the same time the call control processor contains the control software for basic connection and data channel control. The access control protocol is used to exchange messages with the hiQ 9200 feature and route control proxy, which carries out the routing and feature processing. The control proxy also controls all actions which need to be exported to other feature control proxies for feature processing, or communication between two control proxies for call handling if the ports are assigned to different control proxies (each hiA 7600, together with its ports, is assigned for routing purposes to a controller via which it can be accessed and which is aware of the occupancy situation).

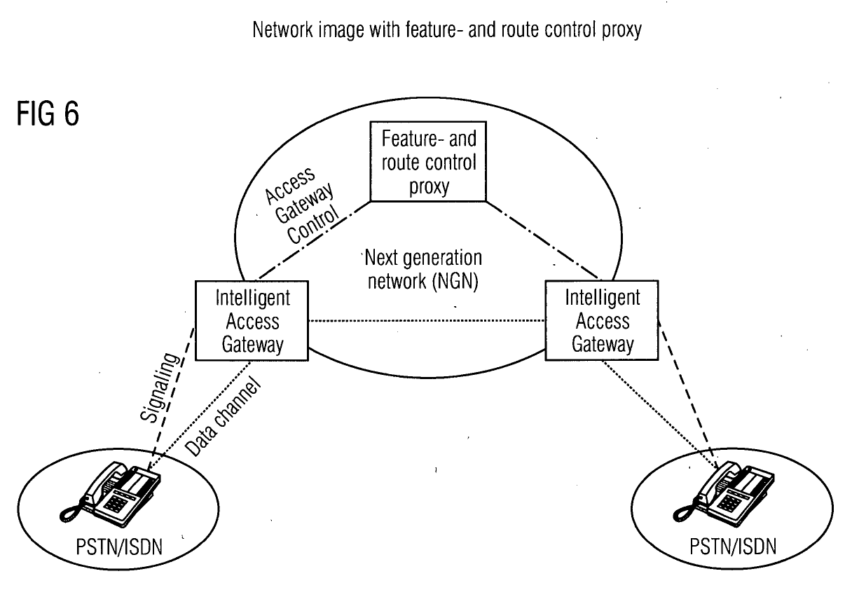

FIG. 6 shows the network image for a basic call in which both ports are assigned to the control proxy.

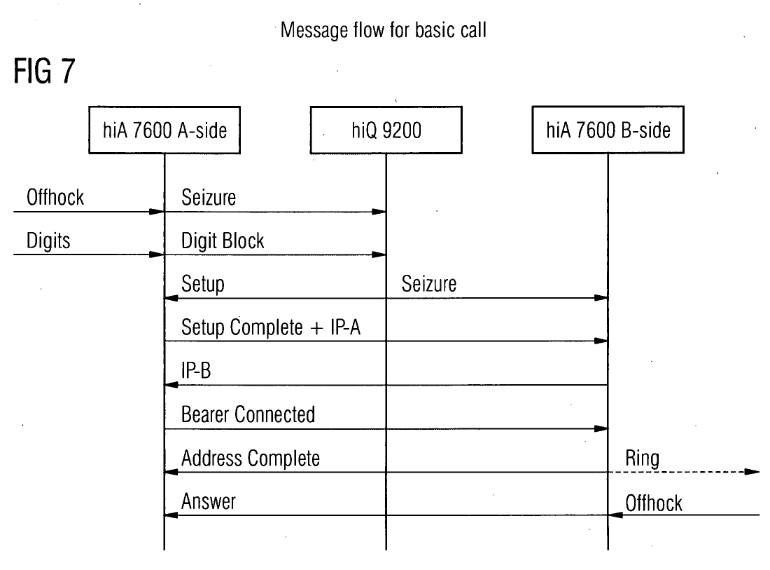

FIG. 7 shows the flow of signaling messages associated with the basic call mentioned in FIG. 6.

As previously mentioned, there are two possible variants for communication between the intelligent access gateways:

Proxy variant a): All messages between two intelligent access gateways (clients) are actually passed via the proxy

Proxy variant b): An intelligent access gateway (client) sends only feature-related and routing-related requests to the proxy. The rest of the communication for connection control purposes passes directly between the clients concerned.

The present example (hiA7600) is based on proxy variant a). All signaling messages—even those which could be exchanged directly between the access gateways—therefore pass via the proxy, but are not processed on the proxy (see FIG. 7).

The message flow in FIG. 7 also makes the following clear:

The subscriber signaling (MFC, DSS1, etc.) is terminated on the intelligent access gateway. The information needed to carry out not only digit processing and routing but also feature handling is sent to the proxy by means of the proxy-client protocol, which in the case of the hiA 7600 means via ACP.

In the case of connection circuits with SS7 signaling, in which the signaling channels in common with the connection circuits are terminated on the intelligent access gateway, MTP and SCCP are not processed by the intelligent access gateway. Only the higher SS7 user parts (e.g. ISUP) are processed on the intelligent access gateway. In the case of the hiQ 9200, it is the task of the signaling gateway integrated in the hiQ 9200 control proxy to process the lower layers of the SS7 protocol.

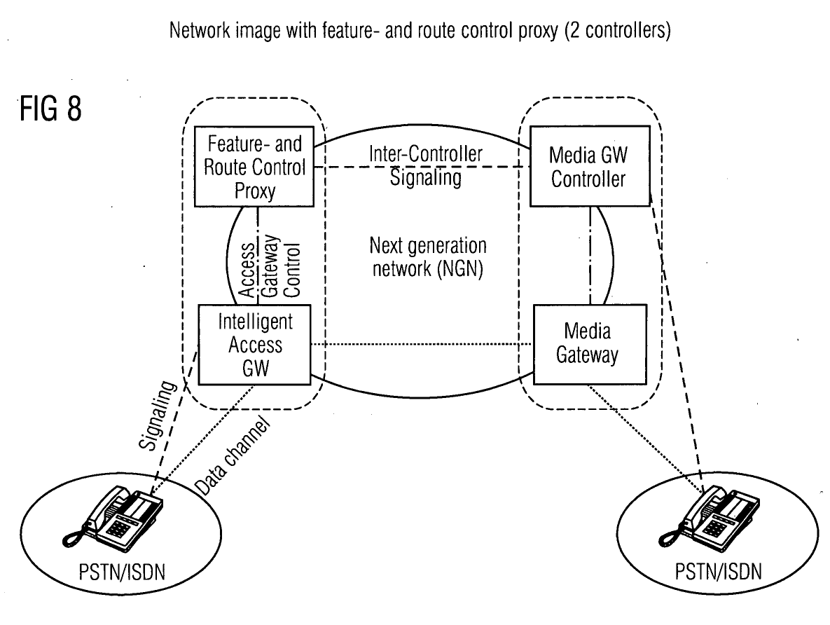

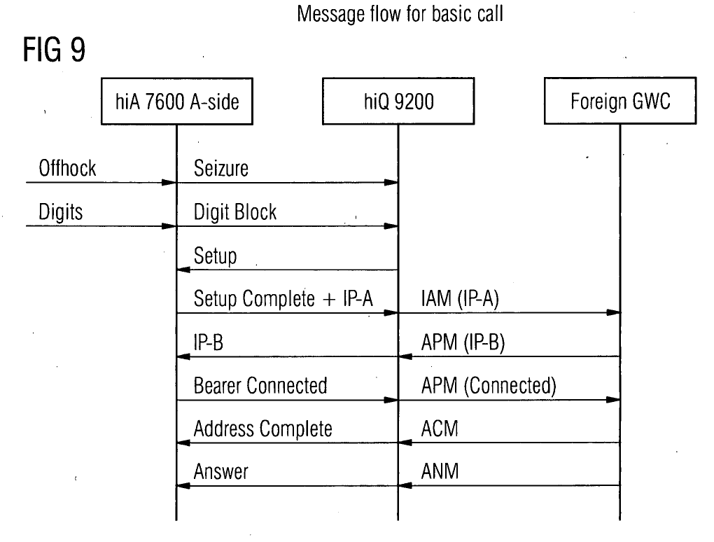

FIG. 8 shows the network image for a basic call in which only incoming access is controlled by the control proxy. FIG. 9 shows the signaling flow associated with FIG. 8.

The outgoing connection can be controlled not only by another control proxy but also by a media gateway controller. The controllers communicate with one another by means of BICC, as shown here, or SIP-T.

Since the control proxy contains the interworking functionality and supports two standardized network-network interface protocols by means of BICC and SIP-T, the different NGN architectures for access control are able to work together within a network.

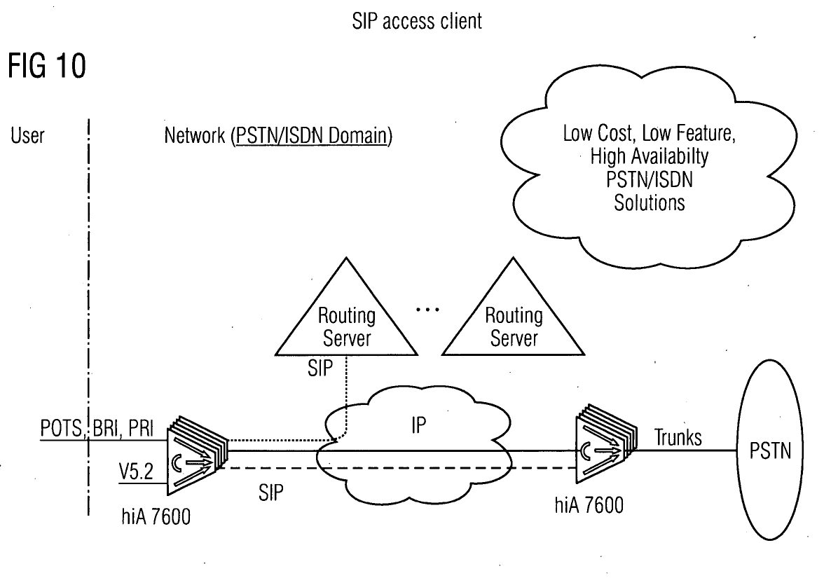

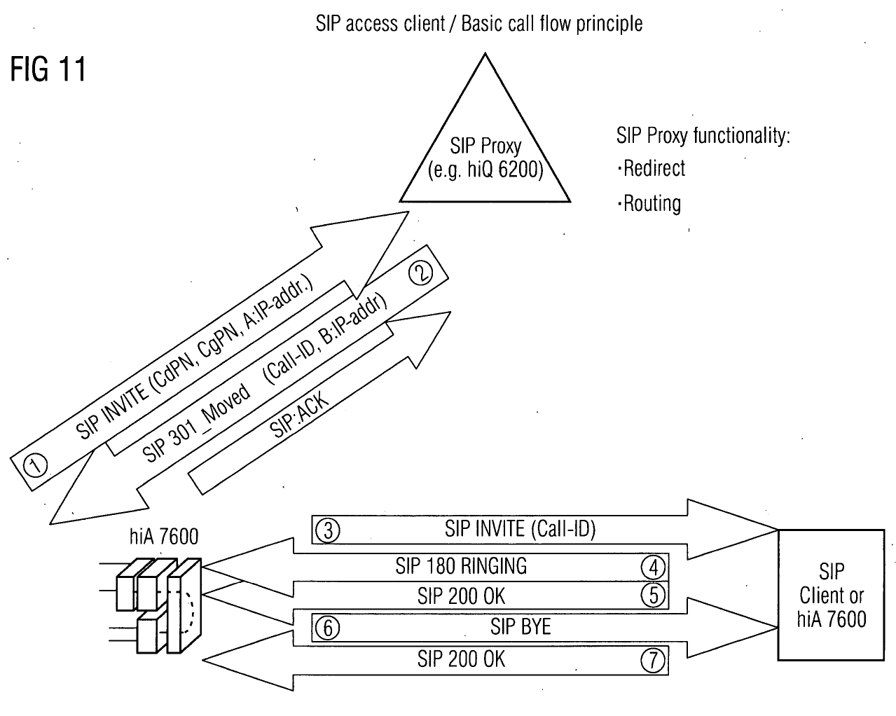

The intelligent access gateway approach corresponds to the function split pursued by SIP, making it possible to integrate access gateways into the world of SIP. The access control protocol is replaced by the standardized SIP protocol (see FIG. 10). SIP signaling is used to establish a session with a SIP proxy. The SIP proxy supplies the necessary information for locating the B subscriber. The scope of the features supported for the subscriber depends on the features supported within the SIP domain.

FIG. 11 shows the flow of messages between clients and the proxy when using SIP.

All conventional subscriber connections (PSTN, ISDN) can be connected to a SIP domain via the intelligent access gateway. This results in a cost-effective and highly available solution for PSTN/ISDN connection.

1-11. (canceled)

12. A media gateway of a packet-based communication network, comprising:
a data channel controller which controls a data channel of a first communication connection;
a terminator that terminates a signaling message of a second communication connection; and
a connection controller that performs a first part of a connection control function for a third communication connection and authorizes a central network controller to carry out a second part of the connection control function.

13. The media gateway according to claim 12, wherein the connection controller performs connection control functions which do not need to be carried out centrally within the network.

14. The media gateway according to claim 13, wherein the connection controller performs connection control functions which are time-critical.

15. The media gateway according to claim 13, wherein the connection controller performs all connection control functions do not need to be carried out centrally within the network.

16. The media gateway according to claims 12, wherein a set of subscriber data is managed.

17. The media gateway according to claims 16, wherein the set of subscriber data is stored.

18. A media gateway according to claim 12, wherein a set of charge data for a communication connection is recorded.

19. A media gateway according to claim 12, wherein an access control protocol is used for communicating with the central network controller.

20. A media gateway according to claim 12, wherein a SIP protocol is used for communicating with the central network controller.

21. A media gateway according to claim 12, wherein a connection control message intended for a second media gateway is sent to the second media gateway via the central network controller.

22. A controller in a packet-based communication network for connection control which carries out connection control functions centrally in the network for a communication connections, comprising:
a media gateway operatively attached to the controller,
wherein the controller receives a task for performing the connection control from the media gateway, the controller either carries out the tasks itself or controls further execution of the tasks instead of the media gateways.

23. A method for handling a communication connection in a packet-based network, comprising:
receiving an incoming signaling message from a circuit selected from the group consisting of subscriber circuit, connection circuit, and combinations thereof;
evaluating the incoming signaling;
performing a first part of a connection control by a media gateway; and
authorizing by the media gateway a central network controller to perform a second part of a connection control.

24. The method according to claim 23, wherein the circuit is not using a SS7 signaling protocol.

25. The method according to claim 23, wherein the circuit is using a SS7 signaling protocol, a user part in the SS7 signaling protocol is received and evaluated by a media gateway after lower protocol layers have been processed by a central network controller which includes a centralized signaling gateway function.
